(19) United States
(12) Patent Application Publication
(10) Pub. No.: US 2019/0023979 A1
(43) Pub. Date: Jan. 24, 2019

(54) METHODS AND COMPOSITIONS FOR FABRIC-BASED SUSPENSION OF PROPPANTS

(71) Applicant: Baker Hughes, a GE company, LLC, Houston, TX (US)

(72) Inventors: James B. Crews, Willis, TX (US); Naima Bestaoui-Spurr, The Woodlands, TX (US); Scott G. Nelson, Cypress, TX (US)

(73) Assignee: Baker Hughes, a GE company, LLC, Houston, TX (US)

(21) Appl. No.: 16/068,776

(22) PCT Filed: Jul. 26, 2017
(86) PCT No.: PCT/US17/43848

§ 371 Date: Jul. 9, 2018

Related U.S. Application Data
(60) Provisional application No. 62/367,269, filed on Jul. 27, 2016.

(51) Int. Cl. C09K 8/80; C09K 8/62; E21B 43/267

(52) U.S. Cl. CPC C09K 8/80; C09K 2208/08; E21B 43/267; C09K 8/62

(57) ABSTRACT

Compositions for suspending proppants in a hydraulic fracture of a subterranean formation involve a carrier fluid, a plurality of proppants, and a plurality of fabric pieces where each fabric includes a plurality of connected filaments. A method of using the compositions includes hydraulically fracturing the subterranean formation to form fractures in the formation; during and/or after hydraulically fracturing the subterranean formation, introducing proppants into the fractures; during and/or after hydraulically fracturing the subterranean formation, introducing fabric in the form of fabric pieces into the fractures, where the fabric contacts and inhibits or prevents the proppant from settling by gravity within the fractures; and closing the fractures against the proppants. Optionally a portion of the fabric pieces may be hydrolyzed. In another option, the fabric pieces may each comprise at least one shape changing filament.

### TECHNICAL FIELD

The present invention relates to methods and compositions for inhibiting or preventing proppants from settling within a hydraulic fracture formed in a subterranean formation; and more particularly relates to methods and compositions for inhibiting or preventing proppants from settling within a hydraulic fracture, which compositions can be readily pumped into the fracture after which a shape change optionally occurs that enhances interacting with the proppants to prevent them from settling.

### TECHNICAL BACKGROUND

Hydraulic fracturing is the fracturing of subterranean rock by a pressurized liquid, which is typically water mixed with a proppant (often sand) and chemicals. The fracturing fluid is injected at high pressure into a wellbore to create, in shale for example, a network of fractures in the deep rock formations to allow hydrocarbons to migrate to the well. When the hydraulic pressure is removed from the well, the proppants, e.g. sand, aluminum oxide, etc., hold open the fractures once fracture closure occurs. In one non-limiting embodiment chemicals are added to increase the fluid flow and reduce friction to give “slickwater” which may be used as a lower-friction-pressure placement fluid. Alternatively in different non-restricting versions, the viscosity of the fracturing fluid is increased by the addition of polymers, such as crosslinked or uncrosslinked polysaccharides (e.g. guar gum) or by the addition of viscoelastic surfactants (VES). The thickened or gelled fluid helps keep the proppants within the fluid.

Recently the combination of directional drilling and hydraulic fracturing has made it economically possible to produce oil and gas from new and previously unexploited ultra-low permeability hydrocarbon bearing lithologies (such as shale) by placing the wellbore laterally so that more of the wellbore, and the series of hydraulic fracturing networks extending therefrom, is present in the production zone permitting production of more hydrocarbons as compared with a vertically oriented well that occupies a relatively small amount of the production zone; see FIGS. 1A and 1B. “Laterally” is defined herein as a deviated wellbore away from a more conventional vertical wellbore by directional drilling so that the wellbore can follow the oil-bearing strata that are oriented in a non-vertical plane or configuration. In one non-limiting embodiment, a lateral wellbore is any non-vertical wellbore. It will be understood that all wellbores begin with a vertically directed hole into the earth, which is then deviated from vertical by directional drilling such as by using whipstocks, downhole motors and the like. A wellbore that begins vertically and then is diverted into a generally horizontal direction may be said to have a “heel” at the curve or turn where the wellbore changes direction and a “toe” where the wellbore terminates at the end of the lateral or deviated wellbore portion. In one non-limiting embodiment, the “sweet-spot” of the hydrocarbon bearing reservoir is an informal term for a desirable target location or area within an unconventional reservoir or play that represents the best production or potential production. The combination of directional drilling and hydraulic fracturing has led to the so-called “fracking boom” of rapidly expanding oil and gas extraction in the US beginning in about 2003.

Most fractures have a vertical orientation as shown schematically in FIG. 1A which illustrates a wellbore 10 having with a vertical portion 12 and a lateral portion 14 drilled into a subterranean formation 16. Through hydraulic fracturing a fracture 28 having an upper fracture 18 and a lower fracture 20 have been created where there is fluid communication between upper and lower fractures 18 and 20, and proppant 22 is shown uniformly or homogeneously distributed in the fracturing fluid 24 of the upper and lower fractures 18 and 20. However, over long fracture closure times, and as the viscosity of the fracturing fluid decreases after fracturing treatments, the proppants 22 settles in the lower fracture 20 and the upper fracture 18 closes without proppant 22 to keep it open, thus operators lose the upper fracture 18 conductivity as schematically illustrated in FIG. 1B. The upper fracture 18 may be the location of the sweet spot horizon 26 of the shale play of the formation 16. The sweet-spot horizon 26 is defined herein as the horizon with in the shale interval to be hydraulically fractured that will produce the most hydrocarbon compared to the shale horizons hydraulically fractured directly above and below.

Efforts have been made to make the proppant pack within a fracture more homogeneous. U.S. Pat. No. 9,010,424 to G. Agrawal, et al. and assigned to Baker Hughes Incorporated involves disintegrative particles designed to be blended with and pumped with typical proppant materials, e.g. sand, ceramics, bauxite, etc., into the fractures of a subterranean formation to prop them open. With time and/or change in wellbore or environmental condition, these particles will either disintegrate partially or completely, in non-limiting examples, by contact with downhole fracturing fluid, formation water, or a stimulation fluid such as an acid or brine. Once disintegrated, the proppant pack within the fractures will lead to greater open space enabling higher conductivity and flow rates. The disintegrative particles may be made by compacting and/or sintering metal powder particles, for instance magnesium or other reactive metal or their alloys. Alternatively, particles coated with compacted and/or sintered nanometer-sized or micrometer sized coatings could also be designed where the coatings disintegrate faster or slower than the core in a changed downhole environment.

Improvements are always needed in the driller's ability to increase and maintain the permeability of a proppant pack within a hydraulic fracture to improve the production of hydrocarbons from the subterranean formation.

### SUMMARY

There is provided in one non-restrictive version, a method of suspending proppants in a hydraulic fracture of a subterranean formation, where the method involves hydraulically fracturing the subterranean formation to form fractures in the formation; during and/or after hydraulically fracturing the subterranean formation, introducing proppants into the fractures; during and/or after hydraulically fracturing the subterranean formation, introducing a plurality of fabric pieces into the fractures, the fabric contacting and inhibiting or preventing the proppant from settling by gravity within the fractures, where the fabric comprises a plurality of connected filaments; and closing the fractures against the proppants.

There is additionally provided in another non-limiting embodiment, a fluid for suspending proppants in a hydraulic fracture of a subterranean formation, where the fluid includes a carrier fluid, a plurality of fabric pieces each comprising a plurality of connected filaments, and a plurality of proppants.

### BRIEF DESCRIPTION OF THE DRAWINGS

FIG. 1A is a schematic illustration of a wellbore with an upper and lower fracture depicting proppant uniformly distributed in a fracturing fluid in the upper and lower fracture, which is under hydraulic pressure to keep it open;

FIG. 1B is a schematic illustration of a wellbore with an upper and lower fracture depicting proppant having settled to the bottom of the lower fracture, the upper and lower fractures having closed, where the upper fracture is substantially completely closed due to the lack of proppant therein;

FIG. 2 is a schematic illustration of a fabric, which in one non-limiting embodiment is woven, where certain of the threads in the fabric are hydrolyzable;

FIG. 3 is a schematic illustration of an upper fracture where proppant and fabric pieces are uniformly or homogeneously distributed in a fracturing fluid under pressure therein;

FIG. 4 is a schematic illustration of the upper fracture of FIG. 3 where the proppant has been held in place by the fabric pieces, the fracture pressure has been released, and the fracture has closed onto the proppants which hold open the fracture;

FIG. 5 is a schematic illustration of the upper fracture of FIG. 4 where some of the threads in the fabric pieces have been hydrolyzed by the fluid in the fracture;

FIG. 6 is a schematic illustration of an upper fracture where proppant and generally straight fabric pieces are uniformly or homogeneously distributed in a fracturing fluid under pressure therein;

FIG. 7 is a schematic illustration of the upper fracture of FIG. 6 where the fabric pieces have changed shape to entangle one another and encounter the proppant and hold it in place, the pressure has been released, and the fracture walls have closed onto the proppants which hold open the fracture;

FIG. 8 is a schematic illustration of an upper fracture where proppant and generally straight, bi-layer fabric pieces are uniformly or homogeneously distributed in a fracturing fluid under pressure therein; and

FIG. 9 is a schematic illustration of the upper fracture of FIG. 8 where one of the layers of the bi-layer fabric pieces has been removed and the remaining layers of the fabric pieces have changed shape to entangle one another and encounter the proppant and hold it in place, the pressure has been released, and the fracture has closed onto the proppants which hold open the fracture.

It will be appreciated that the drawings are not to scale and that certain features have been exaggerated for illustration or clarity.

### DETAILED DESCRIPTION

It has been discovered that fabrics (fabric pieces) and even single pieces of fabric having a wide variety of physical shapes and forms may be transported with proppant into a hydraulic fracture and used to catch, hold, snag, wedge and otherwise engage proppants and temporarily hold them in place within the fracture so that when pumping has been completed and the fracture closes, the fracture faces close against relatively uniformly distributed proppant placement to provide a relatively heterogeneous and uniform improved permeability proppant pack in the fracture as contrasted with an otherwise identical case where no fabric pieces are used.

In one non-limiting embodiment, all or at least a portion of the fabrics are hydrolyzed, dissolved or otherwise removed to clear pathways between the proppants and improve the permeability of the proppant pack.

In a different non-limiting embodiment the fabrics may change shape after they are introduced into the fracture and to configure them to more effectively engage, snarl, catch, hold or snag the proppants in a relatively homogeneous and uniform distribution prior to fracture closure.

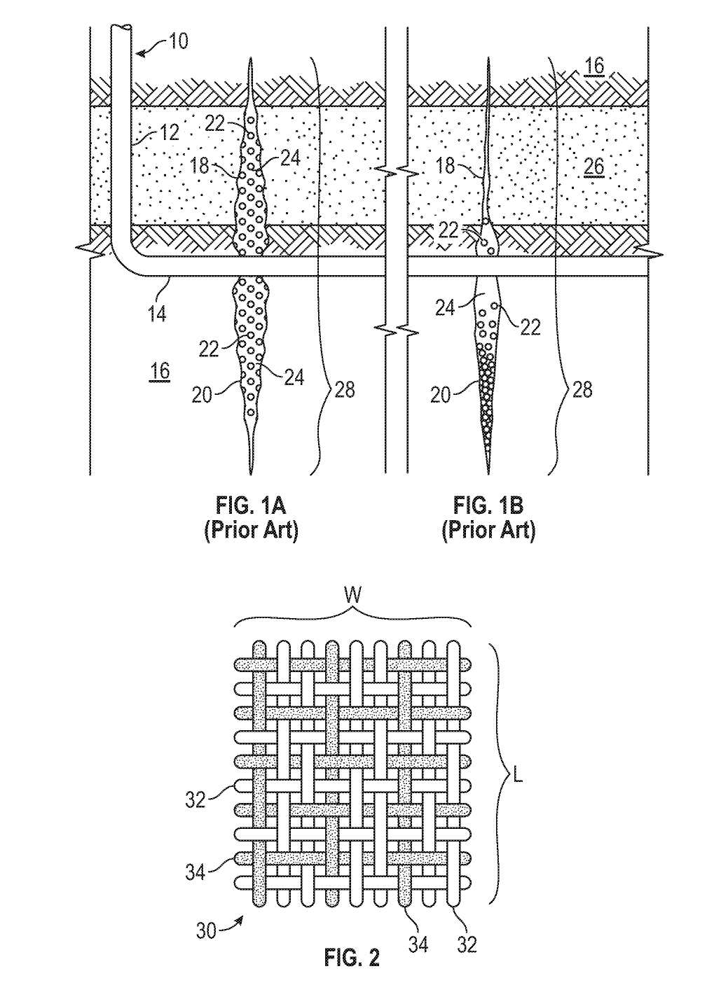

As will be seen, the method described herein further includes vertically distributing the proppant more uniformly and/or more homogeneously in the fracture as compared with an otherwise identical method absent introducing a plurality of fabric pieces. In this way undesirable “banking” of proppant, such as that illustrated in the lower fracture 20 in FIG. 1B is avoided and vertical distribution or placement of the proppant is more uniform and/or uniform in the fracture as compared with an otherwise identical method absent the introducing a plurality of fabric pieces

The fabrics are all functional or functionalized, to have at least two functions or abilities: (1) they must be transportable with a fluid (defined herein as a liquid or gas) downhole to a subterranean formation and a hydraulic fracture within the subterranean formation. They may be part of, contained in, suspended in, dispersed in, and otherwise comprised by the fracturing fluid that fractures the formation. Alternatively they may be introduced subsequently to formation of the hydraulic fracture in a subsequent fluid. Additionally the fabrics must have (2) the function or ability to interact with the fracture face (fractured face of the formation) such as by dragging, skidding, snagging, catching, poking, wedging or otherwise engaging the sides of the fracture while also snagging, catching, holding, wedging, supporting, and otherwise engaging the proppant, which is also in the fluid, thereby holding the proppant in place relative to the fracture face to inhibit and/or prevent and/or be a localized support location for the proppant from settling into the lower portion of the fracture by gravity. In one non-limiting embodiment a localized support location is defined to mean as in a concentration distribution of about every 0.25 inch (about 0.6 cm), or every 0.5 inch, or every 1 inch (about 2.5 cm), or every 2 inches (about 5.1 cm), or every 4 inches (about 10 cm), or every 6 inches (about 15 cm), or even up to every 10 inches (about 25 cm) apart from each other. The fabric pieces will be localized in positions where proppant that begins to settle will only settle so far until they reach a fabric position where the proppant will come to rest upon and not settle any further. Thus the fabric is a localized support location that can vary in distances a part from each other.

The fabric pieces are designed and configured to have a geometry and a composition to interact with fracture walls once treatment is completed, that is, when the treatment pumps are stopped and treatment fluid flow into hydraulic fractures ceases. The functional design of the fabric pieces configures them to interact with the fracture walls to create distributed support structures within the hydraulic fracture where each fabric will physically collect settling proppant particles at each fabric locale. In one non-limiting embodiment, fabrics or fabric pieces in this case means many distributed anti-settling agents configured to act as support structures, where “support structure” means a physical object to obstruct, prevent, restrict, and otherwise control proppant from sedimentation to the bottom of the hydraulic fracture by gravity. In one non-limiting embodiment the fractures are oriented vertically, or to a vertical degree i.e. where proppant settling by gravity is undesirable.

It will be appreciated that it is not necessary for the fabric to hold the proppant fast to the fracture face in the sense of adhering it or fixing it in place. When the fracture closes on the proppant, that is the force and process that holds the proppant in a fixed place and location. The fabric only needs to catch, snag, hold, and/or support the proppant sufficiently to inhibit or prevent it from settling by gravity. It is acceptable if the fabric holds the proppant fast to the fracture face, but it is not necessary because it is expected that as the fracture closes and the space between the opposing fracture walls narrows the proppants may be moved slightly into their permanent places under closure pressure. In other words, the proppants may be temporarily suspended for a time before the fracture closes long enough for their motion downward is inhibited or prevented to keep them from settling in the bottom of the fracture. Thus the fabric pieces must be transportable in a treatment fluid, but also have a physical shape or combination with physical property that interacts with formation face (drag, skid, snag, catch, poke, wedge, etc.), and/or interaction in a fracture network, such as at complex fracture junctions, narrowings of hydraulic fracture, and of course the ultimate property of residing or fixating in the fracture locale once treatment pumping has been completed and be functional by design and physical properties to suspend proppant particles.

It should also be appreciated that while one fabric may be very capable of holding one proppant in place that it is expected that multiple fabric pieces will also catch, snag, collect, and otherwise engage with one another to support and catch one or more proppant to inhibit and/or prevent the proppant from settling due to gravity.

In one simple non-limiting embodiment the fabrics comprise a plurality of connected components or portions or pieces, and in a different non-restrictive version, the pieces, components, or portions are attached, joined, linked, or otherwise connected filaments. A “filament” is defined herein as a slender threadlike object or fiber, including but not necessarily synthetic or polymer monofilament, braided filaments, continuous filaments, or natural filaments found in animal or plant structures. The pieces and/or filaments may be the same or different from one another and the filaments may be of the same or different sizes, diameters, lengths, and/or widths. The plurality of filaments may involve a structure including, but not necessarily limited to, woven, non-woven, knitted, laminated, plied, spun, knotted, stacked, and combinations thereof. Alternatively the fabric pieces may be prepared by a process including, but not necessarily limited to, weaving, knitting, laminating, layering, spinning, knotting, and combinations thereof. Thus, there is a wide variety of configurations in which the filaments may be connected. It will be appreciated that while the fabric pieces may be at least initially configured to have a generally flat structure and/or small cross-sectional profile to permit them to be pumped downhole to be introduced into hydraulic fractures, they will have, or optionally undergo a shape change to have a three-dimensional (3D) structure as well configured to connect with and engage each other, the fracture face(s), and proppant(s).

The fabrics may come from a wide variety of sources and materials including, but not necessarily limited to, straw, wool, cotton hats, such as for cowboy, baseball, beach, etc.; gloves; paper, threaded, and other type of towels including, but not necessarily limited to shop paper towels, bath towels, etc.; padding, absorbent, etc.; sheets, floor mats, carpets, wall repair strip rolls, 3-D cushions in chairs, cars, etc.; fishing, hair, tennis, etc.; nets, scarfs, coats, sails, tight weaved polyester snow ski pants, various designs of overall outfits, blankets with patterns, sweaters with decorative designs, shirts designed for a wide range of purposes (e.g. dress, basketball, breathable, cold weather, stretchable, etc.), table cloths with lace borders, upper portions of shoes, etc.; and combinations of these. In an optional embodiment, the fabrics may be recycled and reused from these and other sources.

The fabrics may be composed of any suitable filaments, conventional or to be developed, including, but not necessary limited to, cotton, wool, silk, fiberglass, polyester, polyurethane, aramid, acrylic, nylon, polyethylene, polypropylene, polyamide, cellulose, polylactide, polyethylene terephthalate, rayon, other synthetic filaments and the like, and combinations thereof. Filament properties to be considered include density, diameter, length, stiffness, surface roughness, linear character (straight, curled, kinked, etc.), solubility, melt temperature, softening temperature, flexibility with heating, etc. Downhole temperatures may vary from about 38° C. to about 205° C., and thus the fabrics need to function at these temperatures. In one non-limiting embodiment the fabric pieces and filaments do not melt at the temperatures to which they are subjected. Other characteristics and properties to consider include, but are not necessarily limited to, stiffness, density, denier, weave, thread count, geometric design and structure (e.g. cloth, netting, etc.), longevity in the expected hydraulic fracture conditions, solubility, combinations of different threads (comingled threads, etc.), dispersibilty (in water, salt water, etc.), transportability (in polymer-viscosified fluid, in viscoelastic surfactant-viscosified fluids, and in non-viscous (water and slickwater) treatment fluids), whether strands in the fabric can be crosslinkable to the treatment fluid polymers like guar (including the amount and degree of crosslinkable sites on select filament strands composing fabric agent), whether the fabrics are hydrophilic or hydrophobic, and combinations of these.

In one optional, non-limiting embodiment the fabric may change shape once they are placed within the hydraulic fracture. In one non-restrictive example, thermal distortion of the fabric may cause selected filaments within the fabric to curl when heated, or otherwise change shape. Such a phenomenon may change the fabric pieces from having a generally flat shape to a more 3D shape permitting them to engage and/or connect with the fracture faces, each other, and the proppants more readily as compared to their initial flat shapes. In another non-limiting embodiment the fabric and/or the filaments composing them may be a shape memory polymer which has one shape, such as a linear or flat shape when it is pumped downhole and introduced into the fractures, and then triggered to have a more 3D different shape, such as curled, spiral, zig-zag, volume increase, and the like. External stimuli to trigger the shape change of a shape memory polymer (SMP) include, but are not necessarily limited to, exposure to or contact with a temperature change, piece or thread or film or component of 3D fabric removal by solubility in water (including solubility in treatment brine and formation brine), an electric field, a magnetic field, a solvent or fluid, presence of monosaccharides and disaccharides, presence of polyenoic acids, application of a stress or force, change in magnetic field, change in electrical field, changes in pH of the fluid surrounding the fabrics, actuation, by dissolving, by hydrolyzing, and combinations thereof. In one non-limiting embodiment, actuation may be defined as a change in a property including, but not necessarily limited to, a change in the shape or thickness that occurs if a force is applied, such as a mechanical force, magnetic field or an electrical field. An electrical field includes electron movement (e.g. static electricity). A magnetic field includes, but is not limited to, spin of the electron (e.g. a permanent magnet). An electromagnetic field is a specific case where the two field types interact with one another, in this case the two fields are at 90° to each other; a moving charge would be a non-limiting example. Suitable shape change polymers include, but are not necessarily limited to, polyester, polycarbonate, polyurethanes, nylon, polyamides, polyimides, polymethylmethacrylate, polyureas, polyvinyl alcohols, vinyl alcohol-vinyl ester copolymers, phenolic polymers, polybenzimidazoles, polyethylene oxide/acrylic acid/methacrylic acid copolymers crosslinked with N, N′-methylene-bis-acrylamide, polyethylene oxide/methacrylic acid/N-vinyl-2-pyrrolidone copolymers crosslinked with ethylene glycol dimethacrylate, polyethylene oxide/poly(methyl methacrylate), N-vinyl-2-pyrrolidone copolymers crosslinked with ethylene glycol dimethacrylate, and combinations thereof. In summary, the fabric comprises at least one shape-changing filament where the shape-changing filament has a first shape and a subsequent shape and the method further comprises introducing the fabric into the fractures when the shape-changing filament has a first shape, and the shape-changing filament changes shape after a period of time within the fractures.

In another non-limiting embodiment at least a portion of the fabric is hydrolyzable before or after the inhibiting or preventing the proppant from settling. “Hydrolyzable” as defined herein is synonymous with dissolvable. Generally, it is expected that the hydrolysis will be achieved by water alone, which includes water and the temperature necessary for overcoming the activation energy required for hydrolysis. Hydrolysis may also be accomplished by water having an acidic or alkaline agent in water in a proportion suitable and/or a pH suitable to dissolve or decompose part or all of the fabric pieces. “Decompose” is defined herein to mean that the disintegration may not generate water soluble chemicals; that is, there may be insoluble portions or pieces remaining. It should be appreciated that the fabric and/or threads do not need to be hydrolyzable or dissolvable, but may be from common, relatively inexpensive materials that may decompose very slowly, such as over the course of many years. Suitable hydrolysable materials include, but are not necessarily limited to, polyvinyl alcohols (PVOH), polylactic acids (PLA), polyglycolic acid (PGA), polyethylene terephthalate (PET), polyesters, polyamides, polycarbonates, and combinations thereof, that at least partially dissolves in water. These materials will be discussed in further detail below.

In one non-limiting embodiment at least a portion of the fabrics introduced into the fractures is hydrolyzable, meaning that of multiple types of fabrics introduced, some fabric pieces are hydrolyzable, or relatively more hydrolyzable than others. Alternatively, or additionally, in another non-restrictive version, at least a portion of each fabric is hydrolyzable.

In a different non-limiting version the fabrics may have two or more layers or laminations. Suitable laminations include, but are not necessarily limited to layers with two or more sheets with different dissolution rates, which may include plastic, woven, and/or non-woven sheets, mesh or net. In a non-limiting example, a netting composed of polyester threads that is manufactured between polyvinyl alcohol (PVOH) sheets or films or as a second layer on a PVOH sheet or film, where during the fracture treatment the PVOH sheets dissolve during heating of the treatment fluid under downhole reservoir conditions to release the polyester netting, optionally including a means to make the netting more flowable during addition to treatment fluid mixing, and more pumpable to downhole reservoir. In another non-limiting embodiment, for instance a constraint such as a thin hydrolyzable coating that dissolves over time or temperature and is no longer substantially present after a time within the fracture may release one or more fabric pieces and/or filaments that are configured to engage the proppants to prevent or inhibit them from settling. The same principle can be used for agents laminated where select sheets or portions dissolve to release a 3D shape, including, but not limited to, a coil, hook, spiral, branch, etc. and combinations thereof.

At its basic form, a laminated fabric may comprise at least a one first filament and at least one second filament, and the method further comprises a change in a parameter selected from the group consisting of temperature, chemical composition, dissolving at least a portion of one of the filaments, change in pH, contact with a chemical that functions as a solvent, a transition metal, a transition metal slow release particle, a slow release acid particle, and a combination thereof so that when at least a portion of the fabric changes, for instance is hydrolyzed, the remaining fabric changes shape.

With respect to the dimensions of the fabrics, it will be understood that the fractures each have at least two opposing fracture walls across a gap and where the fabric singly has at least one dimension that spans the gap between the opposing fracture walls or where multiple fabrics interconnected or entangled with one another spans the gap between the opposing fracture walls. In one non-limiting embodiment the fabric pieces comprise an average length of from about 1 inch independently to about 20 inches (about 2.5 to about 51 cm), alternatively from about 1.5 inch independently to about 15 inches (about 3.8 to about 38 cm), and in another non-limiting embodiment from about 2 inch independently to about 12 inches (about 5.1 to about 31 cm). The term “independently” as used with respect to a range means that any lower threshold may be combined with any upper threshold to give a suitable alternate range. As an example, a suitable alternative average fabric length range would be from about 1.5 inch to about 15 inches.

The fabric pieces may have an average width of from about 0.05 inch independently to about 8 inch (about 1.3 mm to about 20 cm), alternatively from about 0.1 inch independently to about 4 inch (about 2.5 mm to about 10 cm), and in another non-limiting embodiment from about 0.2 inch independently to about 2 inch (about 5 mm to about 5.1 cm). The fabric pieces may have an average thickness of from about 0.002 inch independently to about 0.2 inch (about 0.05 mm to about 5 mm), alternatively from about 0.004 inch independently to about 0.16 inch (about 0.1 mm to about 4 mm), and in another non-limiting embodiment from about 0.008 inch independently to about 0.08 inch (about 0.2 mm to about 2 mm).

In one non-limiting embodiment a minimum aspect ratio is about 1 inch (2.5 cm) long by 0.2 inch (0.5 cm) tall by 0.1 inch (0.25 cm) thick, or about 5 to 1 to 0.5.

The loading or proportion of the fabric pieces in the treatment fluid, fracturing fluid or other carrier fluid, which may be water or brine, range from about 0.1 pounds per thousand gallons (pptg) independently to about 200 pptg (about 0.01 to about 24 kg/m³); from about 0.2 pptg independently to about 100 pptg (about 0.02 to about 12 kg/m³); from about 0.5 pptg independently to about 50 pptg (about 0.06 to about 6 kg/m³).

The present invention will be explained in further detail in the following non-limiting examples that are provided only to additionally illustrate the invention but not narrow the scope thereof.

Shown in FIG. 2 is a schematic representation of one non-limiting embodiment of a fabric 30 having a length L and a width W viewed in a plan orientation and composed of two different types of woven filaments, first filaments 32 (shown as white in this non-limiting embodiment) which are nonhydrolyzable and second filaments 34 (shown as gray in this non-limiting embodiment), which are hydrolyzable. Thickness of fabric 30 is in the direction normal to FIG. 2. It will be appreciated that in the embodiment shown in FIG. 2, even if all of the second filaments 34 are removed by hydrolyzation, first filaments 32 would remain woven together, although as a looser weave.

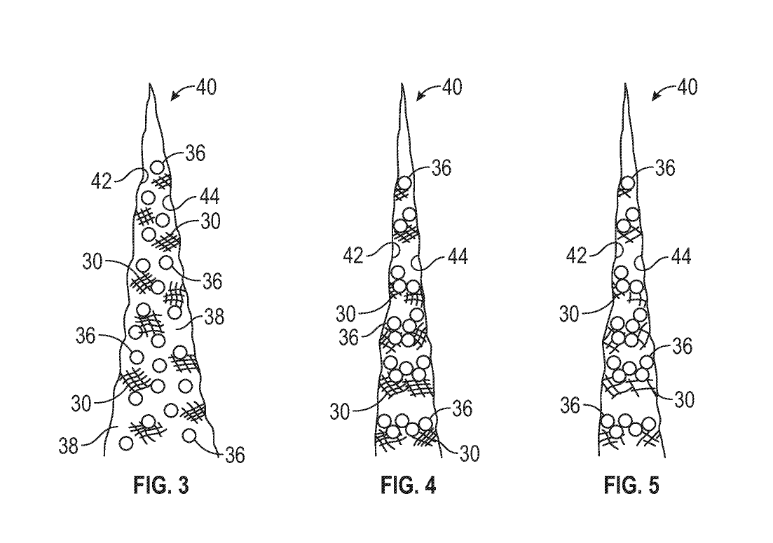

In operation, as schematically shown in FIG. 3, a plurality of fabric pieces 30 are introduced into a hydraulic fracture 40 along with proppants 36 in a uniform dispersion in a treatment fluid 38, which in one non-limiting embodiment may be a brine-based fracturing fluid. The fracture 40 has a first fracture face 42 and an opposing, second fracture face 44. As the pumping pressure eases or is removed, fracture faces 42 and 44 collapse toward each other and fabric pieces 30 and proppants 36 are urged toward each other in a reduced volume. Fabric pieces 30 singly and in groups bridge the gap between faces 42 and 44 and catch, grab, ensnare, and otherwise inhibit and prevent proppants 36 from settling by gravity and thus proppants 36 keep between fracture walls 42 and 44, and prop the fracture 40 open after the pressure is completely released and the fracture 40 closes as much as possible, but for the presence of the proppants, as schematically illustrated in FIG. 4. It will be appreciated that a single fabric may hold, suspend, or otherwise fixate a plurality of proppant particles. It will be additionally appreciated that introducing the fabrics into the fractures can comprise employing a carrier fluid where a proportion of fabrics in the carrier fluid act to interconnect other multiple individual fabric pieces into larger connected lengths or a plurality of variable shapes, and which can range in concentration from about 0.01 pptg to about 20 pptg (about 0.001 to about 2.4 kg/m³). It will be further appreciated that the sizes of the proppants 36 and fabric pieces 30 relative to the fracture 40 have been exaggerated for illustrative purposes and are not to scale. If nothing else happened, the method and composition would be a success because permeability of the fracture 40 would be improved as compared with upper fracture 18 as shown in FIG. 1B as almost completely closed or collapsed.

Over time and/or temperature, the hydrolyzable second filaments 34 of fabric pieces 30 dissolve and hydrolyze to give the schematic depiction of FIG. 5 which schematically shows that as least some of the fabric pieces 30 have been hydrolyzed to further improve the permeability of the proppant pack within fracture 40. However, by this time fracture 40 has closed and the proppants 36 are permanently in place and fabric pieces 30 are no longer needed. Indeed, in one non-limiting embodiment, all of fabrics 30 may be hydrolyzed to further improve the permeability of the proppant pack. Depending on the situation, and how precisely and over what period of time the fabrics 30 and proppants 36 may be placed in fracture 40, it may be desirable for some first filaments 32 and possibly second filaments 34 to remain even after some second filaments 34 have been partially or completely hydrolyzed, to be sure that the proppants are inhibited or prevented from settling prior to fracture 40 closing. Alternatively, first filaments 32 and second filaments 34 may both be hydrolyzable, but at different rates.

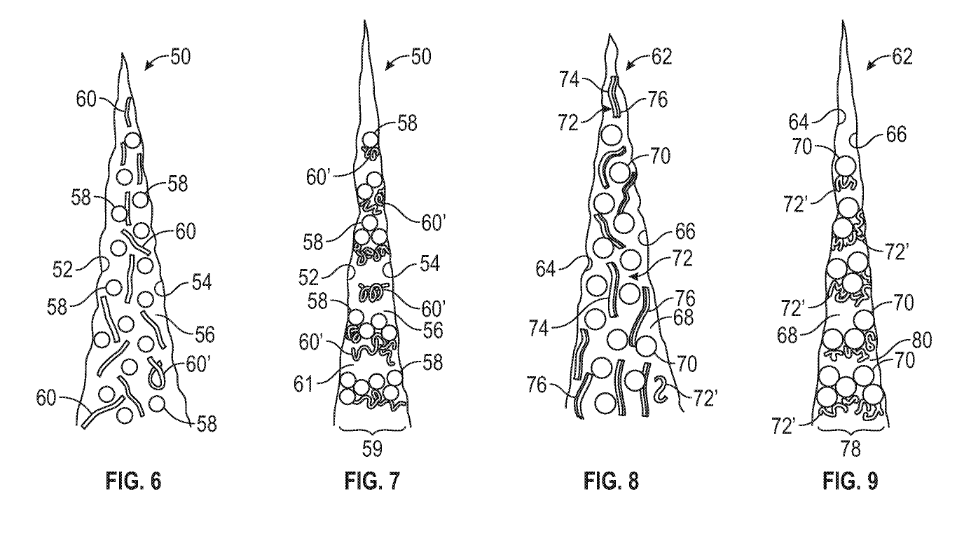

Shown in FIGS. 6 and 7 is another embodiment of the methods and compositions described herein, where hydraulic fracture 50 has a first fracture face 52 and an opposing, second fracture face 54 into which has been pumped under pressure a brine-based fracturing fluid 56 containing proppants 58 and fabric pieces 60. In the particular embodiment schematically illustrated in FIGS. 6 and 7, fabrics 60 are shape-memory polymers (SMPs) or the like thermo-responsive polymers engineered and designed so that at an elevated temperature they have a more convoluted shape that occupies more three-dimensional volume, such as a coil, spring, spiral, corkscrew, box, cube, pyramid, or the like, but are shaped and frozen at a lower temperature (below the glass transition temperature, T_{g}, of the polymer) into a generally linear shape, as shown in FIG. 6, that permits them to be more readily pumped or otherwise introduced into fracture 50. The method is designed so that once all of the proppants 58 and fabric pieces 60 are introduced into the fracture, and the fabric pieces 60 have been present in the fracture a sufficient time at the downhole temperature to heat up above their Tg, they begin to revert to their original shape, such as a spiral or corkscrew. See for instance fabric 60′ near the bottom of FIG. 6 that is beginning to change shape. The fabrics all revert to their spring, coil, spiral or other shape occupying more 3D space, bridge the fracture faces 52 and 54 either by themselves or after engaging, entangling and grouping with other fabric pieces 60′ that have reverted to shapes that cause them to more readily engage other fabric pieces 60′, the fracture faces 52 and 54 and particularly the proppants 58 to inhibit or prevent the proppants 58 from settling and descending and to remain in the fracture 50 in place so that when the hydraulic pressure of the fracturing fluid 56 is reduced or removed as schematically shown in FIG. 7, the fracture faces 52 and 54 remain propped open by the proppants 58 thereby providing a proppant pack of increased permeability because fracture 50 was not permitted to collapse. It will be appreciated that in some non-limiting embodiments pillars 59 composed of proppant 58 are formed; for instance, see the pillar 59 at the bottom of FIG. 7 positioned between fracture faces 52 and 54. A space or void 61 would be present between each adjacent pillar 59. Pillar 59 may optionally also be composed of fabric 60′. No part of the fabric 60 needs to be hydrolyzable in this embodiment. It should also be recognized that shapes of fabrics 60′ need not be the same as one another so long as most of them (greater than 50% in one non-limiting embodiment) are functional to engage each other, the fracture faces 52 and 54 and particularly the proppants 58 to inhibit or prevent the proppants 58 from settling.

Shown in FIGS. 8 and 9 is a different non-restrictive embodiment of the methods and compositions described herein, where hydraulic fracture 62 has a first fracture face 64 and an opposing, second fracture face 66 into which has been pumped under pressure a brine-based fracturing fluid 68 containing proppants 70 and fabric pieces 72. In the particular embodiment schematically illustrated in FIGS. 8 and 9, fabric pieces 72 each have at least two layers or filaments, a first layer or filament 74 (white in this example) and a second layer or filament 76 (black in this example), where fabrics 72 are engineered and designed so that at sufficient exposure to a solvent, such as water, the second layer or filament 76 dissolves and no longer constrains the shape of first layer or filament 74, and first layer or filament 74 assumes or takes on a more convoluted shape that occupies more of three-dimensional volume, such as a coil, spring, spiral, corkscrew, box, cube, pyramid, or the like. The fabric pieces 72 have a generally linear shape, as shown in FIG. 8, which permits them to be more readily pumped or otherwise introduced into fracture 62. The method is designed so that once all of the proppants 70 and fabrics 72 are introduced into the fracture, and the fabric pieces 72 have been present in the fracture a sufficient time so that second layer or filament 76 dissolves in the brine 68 and remaining first layer or filament 74 takes on a more convoluted shape, such as a spiral or corkscrew or spring. See for instance fabric 72′ near the bottom of FIG. 8 that is beginning to change shape, since second layer or filament 76 has dissolved and is no longer present. Most or all of the fabric pieces 72′ change into springs, coils, spirals or other shapes occupying more 3D space, and bridge the fracture faces 64 and 66 either by themselves or after engaging, entangling and grouping with other fabrics 72′ many or most of which have reverted to shapes that cause them to more readily engage other fabrics 72′, the fracture faces 64 and 66 and particularly the proppants 70 to inhibit or prevent the proppants 70 from settling and descending and to remain in the fracture 62 in place so that when the hydraulic pressure of the fracturing fluid 68 is reduced or removed, as schematically shown in FIG. 9, the fracture faces 64 and 66 remain propped open by the proppants 70 thereby providing a proppant pack of increased permeability because fracture 62 was not permitted to fully collapse. Again, it should be recognized that shapes of fabric pieces 72′ need not be the same as one another so long as most of them (greater than 50%, in one non-limiting embodiment) are functional to engage each other, the fracture faces 64 and 66 and particularly the proppants 70 to inhibit or prevent the proppants 70 from settling. And in a different non-limiting embodiment, it will be appreciated that in some non-limiting embodiments pillars 78 composed of proppant 70 are formed; for instance, see the pillar 78 at the bottom of FIG. 9. Pillar 78, extending between first fracture face 64 and second fracture face 66 may optionally also be composed of fabric 72′. A space or void 80 would be present between each pillar 78 to more readily permit the production and flow of hydrocarbons through the fracture. Again, no part of the fabric 72 needs to be hydrolyzable in this embodiment.

In the foregoing specification, the invention has been described with reference to specific embodiments thereof, and has been described as effective in providing methods and compositions for using fabrics or fabric pieces to inhibit or prevent the settling of proppants in fractures. However, it will be evident that various modifications and changes can be made thereto without departing from the broader invention as set forth in the appended claims. Accordingly, the specification is to be regarded in an illustrative rather than a restrictive sense. For example, specific combinations of fabrics; fabric pieces; filaments; threads; polymers; laminations; functional structures; proppants; treatment, fracturing and other carrier fluids; brines; acids; dimensions; proportions; aspect ratios; materials; and other components falling within the claimed elements and parameters, but not specifically identified or tried in a particular method or composition, are anticipated to be within the scope of this invention. Similarly, it is expected that the methods may be successfully practiced using different sequences, loadings, pHs, compositions, structures, temperature ranges, and proportions than those described or exemplified herein.

The words “comprising” and “comprises” as used throughout the claims is interpreted to mean “including but not limited to”.

The present invention may suitably comprise, consist of or consist essentially of the elements disclosed and may be practiced in the absence of an element not disclosed. For instance, there may be provided a method of suspending proppants in a hydraulic fracture of a subterranean formation, where the method consists essentially of or consists of hydraulically fracturing the subterranean formation to form fractures in the formation; during and/or after hydraulically fracturing the subterranean formation, introducing proppants into the fractures; during and/or after hydraulically fracturing the subterranean formation, introducing a plurality of fabric pieces into the fractures, the fabric pieces contacting and inhibiting or preventing the proppant from settling by gravity within the fractures, where the fabric pieces comprise a plurality of connected filaments; and closing the fractures against the proppants.

In another non-limiting embodiment, there may be provided a fluid for suspending proppants in a hydraulic fracture of a subterranean formation, the fluid consisting essentially of or consisting of a carrier fluid; a plurality of fabric pieces each comprising a plurality of connected filaments; and a plurality of proppants.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

1. A method of suspending proppants in a hydraulic fracture of a subterranean formation, the method comprising:
hydraulically fracturing the subterranean formation to form fractures in the formation;
during and/or after hydraulically fracturing the subterranean formation, introducing proppants into the fractures;
during and/or after hydraulically fracturing the subterranean formation, introducing a plurality of fabric pieces into the fractures, the fabric pieces contacting and inhibiting or preventing the proppant from settling by gravity within the fractures, where the fabric pieces comprise a plurality of connected filaments; and
closing the fractures against the proppants.

2. The method of claim 1 where the fabric pieces comprise a plurality of filaments prepared by a process selected from the group consisting of:
weaving,
knitting,
laminating,
layering,
spinning,
knotting,
stacking, and
combinations thereof.

3. The method of claim 1 where the fractures each have at least two opposing fracture walls across a gap and where the fabric pieces singly have at least one dimension that spans the gap between the opposing fracture walls or where multiple fabric pieces interconnected with one another spans the gap between the opposing fracture walls.

4. The method of claim 1 further comprising hydrolyzing at least a portion of the fabric pieces after the inhibiting or preventing the proppant from settling.

5. The method of claim 1 where the fabric pieces comprise at least one shape-changing filament where the shape-changing filament has a first shape and a subsequent shape and the method further comprises:
introducing the fabric pieces into the fractures when the shape-changing filament has a first shape; and
the shape-changing filaments changing shape after a period of time within the fractures.

6. The method of claim 5 where the shape-changing filament comprises a shape memory polymer and changing shape is triggered by a cause selected from the group consisting of contact with a solvent, heating above a threshold temperature, a mechanical force, an electric field, a magnetic field, a change in pH of a fluid, the presence of monosaccharide, disaccharides, presence of polyenoic acids, by dissolving, by hydrolyzing, application of stress or force, change in magnetic field, change in electric field, and combinations thereof.

7. The method of claim 1 where the fabric pieces comprise at least a one first filament and at least one second filament, and the method further comprises a change in a parameter selected from the group consisting of temperature, chemical composition, dissolving at least a portion of one of the filaments, by dissolving, by hydrolyzing, an actuation due to an applied stress or force or magnetic or electric field, and a combination thereof which causes a shape change in at least one of the filaments.

8. The method of claim 7 where at least one of the first filament and/or the second filament is a hydrolysable material selected from the group consisting of polyvinyl alcohols (PVOH), polylactic acids (PLA), polyglycolic acid (PGA), polyethylterephthalate (PET), polyesters, polyamides, polycarbonates, and combinations thereof, that at least partially dissolves in water.

9. The method of claim 1 where the filaments are selected from the group consisting of cotton, wool, silk, fiberglass, polyester, polyurethane, aramid, acrylic, nylon, polyethylene, polypropylene, polyamide, cellulose, polylactide, polyethylene terephthalate, rayon, and combinations thereof.

10. The method of claim 1 where the fabric pieces comprise:
an average length of from about 1 inch to about 20 inches (about 2.5 to about 51 cm);
an average width of from about 0.05 inch to about 8 inch (about 1.3 mm to about 20 cm); and
an average thickness of from about 0.002 inch to about 0.2 inch (about 0.05 mm to about 5 mm).

11. The method of claim 1 where the fabric pieces have a minimum aspect ratio of length to width to thickness that is about 5 to 1 to 0.5.

12. The method of claim 1 where introducing the fabric pieces into the fractures comprises employing a carrier fluid where a proportion of fabric pieces in the carrier fluid ranges from about 0.1 pptg to about 200 pptg (about 0.01 to about 24 kg/m³).

13. The method of claim 1 where introducing the fabric pieces into the fractures comprises employing a carrier fluid where a proportion of fabric pieces in the carrier fluid act to interconnect other multiple individual fabric pieces into larger connected lengths or a plurality of variable shapes, and which range in concentration from about 0.01 pptg to about 20 pptg (about 0.001 to about 2.4 kg/m³).

14. The method of claim 1 further comprising forming pillars within the fractures, where the pillars comprise proppant.

15. The method of claim 1 further comprising vertically distributing the proppant more uniformly in the fracture as compared with an otherwise identical method absent introducing a plurality of fabric pieces.

16. A fluid for suspending proppants in a hydraulic fracture of a subterranean formation, the fluid comprising:
a carrier fluid;
a plurality of proppants;
a plurality of fabric pieces each comprising a plurality of connected filaments.

17. The fluid of claim 16 where the fabric pieces comprise a plurality of filaments prepared by a process selected from the group consisting of:
weaving,
knitting,
laminating,
layering,
spinning,
knotting,
stacking, and
combinations thereof.

18. The fluid of claim 16 where at least a portion of the fabric pieces is hydrolyzable.

19. The fluid of claim 16 where at least a portion of the fabric pieces comprise at least one shape-changing filament where the shape-changing filament has a first shape and a subsequent shape

20. A method of suspending proppants in a hydraulic fracture of a subterranean formation, the method comprising:
hydraulically fracturing the subterranean formation to form fractures in the formation, where the fractures each have at least two opposing fracture walls across a gap;
during and/or after hydraulically fracturing the subterranean formation, introducing proppants into the fractures;
during and/or after hydraulically fracturing the subterranean formation, introducing a plurality of fabric pieces into the fractures, the fabric pieces contacting and inhibiting or preventing the proppant from settling by gravity within the fractures, where the fabric pieces comprise a plurality of connected filaments, where the fabric pieces singly have at least one dimension that spans the gap between the opposing fracture walls or where multiple fabric pieces interconnected with one another spans the gap between the opposing fracture walls, and where the filaments are selected from the group consisting of cotton, wool, silk, fiberglass, polyester, polyurethane, aramid, acrylic, nylon, polyethylene, polypropylene, polyamide, cellulose, polylactide, polyethylene terephthalate, rayon, and combinations thereof; and
closing the fractures against the proppants.
